(19) United States
(12) Patent Application Publication
(10) Pub. No.: US 2021/0075800 A1
(43) Pub. Date: Mar. 11, 2021

(54) ETHERNET NETWORK-PROFILING INTRUSION DETECTION CONTROL LOGIC AND ARCHITECTURES FOR IN-VEHICLE CONTROLLERS

(71) Applicant: GM GLOBAL TECHNOLOGY OPERATIONS LLC, Detroit, MI (US)

(72) Inventors: Evripidis Paraskevas, Royal Oak, MI (US); Yuchen Zhou, Warren, MI (US); Unmesh Dutta Bordoloi, Troy, MI (US); Massimo Osella, Troy, MI (US); Michael E. Potts, Warren, MI (US)

(73) Assignee: GM GLOBAL TECHNOLOGY OPERATIONS LLC, Detroit, MI (US)

(21) Appl. No.: 16/642,262

(22) PCT Filed: Dec. 15, 2017
(86) PCT No.: PCT/GR2017/000070

§ 371 Date: Feb. 26, 2020

(51) Int. Cl. H04L 29/06; H04L 29/08

(52) U.S. Cl. CPC H04L 63/1416; H04L 63/1441; H04L 67/12

(57) ABSTRACT

Presented herein are intrusion detection systems and algorithms for networked vehicle controllers and devices, methods for making/using such systems and algorithms, and motor vehicles with a network of ECUs and network-profiling intrusion detection capabilities. A method for detecting intrusions into an onboard network of vehicle controllers includes determining the current state of operation of a vehicle, and identifying a network traffic pattern table corresponding to the vehicle's current state of operation. Network traffic flow for one of the in-vehicle controllers is monitored when exchanging data over the Ethernet communication interface while the motor vehicle is operating in the current state of operation. The method then determines if a traffic characteristic of the monitored network traffic flow is outside a calibrated boundary that is determined from the network traffic pattern table. Responsive to the monitored network traffic flow characteristic being outside the calibrated boundary, the method executes a remedial action response.

### CLAIM OF PRIORITY AND CROSS-REFERENCE TO RELATED APPLICATION

This application is a U.S. National Phase entry of International Patent Application No. PCT/GR2017/000070, which was filed on Dec. 15, 2017, and is incorporated herein by reference in its entirety and for all purposes.

### INTRODUCTION

The present disclosure relates generally to distributed computing networks and computer networking protocols. More specifically, aspects of this disclosure relate to system architectures and control logic for detecting unauthorized access to in-vehicle networked controllers and devices that provide distributed control of vehicle functions.

Current production motor vehicles, such as the modern-day automobile, are originally equipped with a network of electronic controllers and computing devices distributed throughout the vehicle to perform various vehicle functions. These vehicle functions, whether fully or partially automated, may include controlling vehicle door locks, seat position, cruise control, entertainment system components, heating ventilation and air conditioning (HVAC), the arming/disarming of theft-prevention systems, interior and exterior lighting, powertrain operation and system diagnostics, and vehicle-assisted “autonomous” driving maneuvers. While some onboard electronic control units (ECU), such as the engine control module (ECM), transmission control modules (TCM), and brake system control module (BCM), are often dedicated to controlling a single subsystem, other ECUs function in interoperable groups to collaboratively control vehicle operations. Many vehicle control tasks are performed by several ECUs working in unison and coordinating their operation via a data link. Some embedded vehicle ECUs, for example, may contain a portion of the control logic for several unrelated vehicle control tasks, yet may not contain the complete control logic for any single control task.

In-vehicle controllers often communicate with one another via a network communication bus or an Ethernet switch, either of which may be implemented singly or as serial communication interfaces in the form of a local area network (LAN). In addition to the requisite hardware for transferring signals between networked ECUs, a reliable communication protocol is implemented to help ensure that primary and ancillary tasks can be performed synchronously. One such task is network management to provide a system-wide common methodology for handling such events as orderly start up (activation) and shutdown (deactivation) of communication capabilities, and predictable recovery from detectable communication errors. Orderly startups and shutdowns help to ensure that ECUs can synchronize their signal reception expectations with signal transmission availability of other ECUs. Other tasks requiring reliable network communication to ensure controller synchronicity involve governing powertrain, steering and braking operations to execute vehicle-assisted driving maneuvers. In fully and partially autonomous vehicle architectures, for example, dependable and unimpeded communication exchanges between the ECM, TCM and BCM, as well as other resident and remote devices, is paramount to securely execute routine and atypical operations.

As original equipment manufacturers (OEM) move towards interconnected “talking” cars with higher-level driving automation, including Level 4 and Level 5 fully autonomous passenger vehicles, computer-networked hacking of in-vehicle controllers and malware corruption of vehicle electronic control systems is becoming a more pervasive threat. Attacks on a vehicle's distributed controller network may be achieved using one of the vehicle's wireless Ethernet bridges or other wireless data port, where the intruder executes malicious code to corrupt and hijack one of the ECUs. The intruder then exploits the compromised ECU as an entry point for attacking other system nodes and important operating system files, including transmitting malicious code or illicit commands to more sensitive ECUs. To thwart such unauthorized access—referred to in the industry as an “intrusion”—OEMs are implementing various intrusion detection software applications to monitor the vehicle's controller network and prevent any attendant malicious activities and policy violations.

### SUMMARY

Disclosed herein are intrusion detection system (IDS) architectures and logic for in-vehicle networked controllers and devices, methods for implementing and methods for constructing such architectures/algorithms, and motor vehicles equipped with network-profiling intrusion detection capabilities for identifying and preventing unauthorized intrusions into onboard networks of ECUs. By way of example, there is presented an automotive Ethernet network-profiling intrusion detection method for detecting several types of attacks and systematic faults of networked controllers by leveraging knowledge of network traffic patterns. The disclosed method is designed to both discover and frustrate attacks where an ECU (with an embedded Ethernet switch) has been compromised. Intrusion detection is accomplished, in part, by identifying anomalies in network profiles and traffic patterns, including aberrations in source-destination pairs, message frequency, message quantity, latency of traffic flow, etc. The Ethernet IDS framework works for both static scenarios, where network patterns do not change from driving mode to driving mode (one “mode” of operation), and dynamic scenarios, where network patterns vary from driving mode to driving mode and for different operational states of the controllers.

Attendant benefits for at least some of the disclosed intrusion detection architectures and algorithms include low computational overhead as compared to other market available in-vehicle intrusion detection methods. In addition, at least some of the disclosed methodologies are independent of automotive network domains and topology and, thus, are more readily scalable and adaptable for different vehicle platforms. Other attendant benefits may include the ability to adapt network traffic patterns to individual users, and to enhance the ingress policies generally used in Ethernet switches. Another advantage may include the ability to enable more secure usage of Ethernet backbone architectures in automotive applications. Secure and protected network convergence, with reduced risk of hacking and infection, is enabled through improved system intrusion detection, isolation, and prevention techniques.

Aspects of this disclosure are directed to network-profiling intrusion detection logic and computer-executable algorithms for identifying and preventing unauthorized intrusions into networked vehicle controllers. For instance, a method is presented for detecting an intrusion into an onboard network of electronic controllers of a motor vehicle. The representative method includes, in any order and in any combination with any of the disclosed features and options: determining a current state of operation of the motor vehicle; identifying a network traffic pattern table corresponding to the current state of operation of the motor vehicle; monitoring network traffic flow for one or more of the electronic controllers when each controller is exchanging data over the Ethernet communication interface while the motor vehicle is operating in the current state of operation; determining if a traffic characteristic of the monitored network traffic flow is outside a calibrated boundary determined from the network traffic pattern table; and, executing a remedial action in response to the traffic characteristic of the monitored network traffic flow being outside the calibrated boundary.

Continuing with the discussion of the above example, the remedial action may include transmitting an audio and/or visual alert to the vehicle driver, e.g., via a digital instrument panel (IP) or a center stack display device, and/or transmitting an electronic alert to a remote server indicating detection of an anomaly and potential intrusion. As further options, the remedial action may include generating an interrupt signal to discontinue further exchanges of data by the corrupted controller(s), storing in a resident or remote memory device a record of the detected anomaly, and/or modulating an automated vehicle driving maneuver affected by the intrusion. Monitoring the network traffic flow of a select controller may include receiving Ethernet frames from a designated port of the Ethernet communication interface, and identifying a specified field within one or more Ethernet frames with data indicative of the traffic characteristic.

Other aspects of the present disclosure are directed to motor vehicles equipped with an onboard network of vehicle controllers and computing devices (collectively “controllers” or “ECUs”), and control logic for governing the operation of these controllers. As used herein, the terms “motor vehicle” and “vehicle” may be used synonymously and interchangeably to include any relevant vehicle platform, such as passenger vehicles (internal combustion engine, hybrid electric, full electric, fuel cell, fuel cell hybrid, fully or partially autonomous, etc.), commercial vehicles, industrial vehicles, tracked vehicles, off-road and all-terrain vehicles (ATV), farm equipment, watercraft, aircraft, etc. In an example, a motor vehicle is presented that includes a vehicle body, an engine and/or a motor mounted to the vehicle body, and multiple road wheels attached to the vehicle body and drivingly connected to the engine/motor. A network of electronic control units is distributed throughout the vehicle body, with one or more Ethernet communication interfaces wirelessly connecting the network of ECUs to a distributed computing network. For at least some system architectures, an Ethernet communication interface is embedded within each of the networked ECUs.

Continuing with the above example, a dedicated vehicle controller, which may be in the nature of a Central Control Module (CCM) or a General Electronic Module (GEM), is communicatively connected to the network of ECUs. This controller is programmed to ascertain the current operational state of the vehicle (e.g., Society of Automotive Engineers (SAE) Levels 0-5 vehicles), and identify a network traffic pattern table that corresponds to the vehicle's current state of operation. The vehicle controller then monitors network traffic flow for one or more or all of the vehicle's networked ECUs while the ECU/ECUs exchange data over the Ethernet communication interface(s) as the vehicle is operated in the current state of operation. The vehicle controller then determines if any one or more network traffic pattern characteristics of a designated set of traffic characteristics associated with the monitored network traffic flow is/are outside a corresponding calibrated boundary as determined from the network traffic pattern table. The controller will execute a remedial action in response to any one of the traffic characteristics of the monitored traffic flow being outside its respective calibrated boundary.

The above summary is not intended to represent every embodiment or every aspect of the present disclosure. Rather, the foregoing summary merely provides an exemplification of some of the novel concepts and features set forth herein. The above features and advantages, and other features and advantages, will be readily apparent from the following detailed description of illustrated embodiments and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a schematic illustration of a representative motor vehicle with a network of in-vehicle controllers and devices and an Ethernet-network profiling intrusion detection system in accordance with aspects of the present disclosure.

FIG. 2 is a schematic diagram of a representative in-vehicle Ethernet network illustrating an example of an attack scenario and intrusion detection response in accordance with aspects of the present disclosure.

FIG. 3 is a flowchart for a network profiling intrusion detection protocol that may correspond to instructions executed by onboard control-logic circuitry, programmable electronic control unit, or other computer-based device of a motor vehicle in accord with aspects of the disclosed concepts.

The present disclosure is amenable to various modifications and alternative forms, and some representative embodiments have been shown by way of example in the drawings and will be described in detail herein. It should be understood, however, that the novel aspects of this disclosure are not limited to the particular forms illustrated in the above-enumerated drawings. Rather, the disclosure is to cover all modifications, equivalents, combinations, subcombinations, permutations, groupings, and alternatives falling within the scope of this disclosure as defined by the appended claims.

### DETAILED DESCRIPTION

This disclosure is susceptible of embodiment in many different forms. There are shown in the drawings and will herein be described in detail representative embodiments of the disclosure with the understanding that these illustrated examples are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference or otherwise.

For purposes of the present detailed description, unless specifically disclaimed: the singular includes the plural and vice versa; the words “and” and “or” shall be both conjunctive and disjunctive; the word “all” means “any and all”; the word “any” means “any and all”; and the words “including” and “comprising” and “having” mean “including without limitation.” Moreover, words of approximation, such as “about,” “almost,” “substantially,” “approximately,” and the like, may be used herein in the sense of “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., are with respect to a motor vehicle, namely a forward driving direction of a motor vehicle when the vehicle is operatively oriented on a normal driving surface, for example.

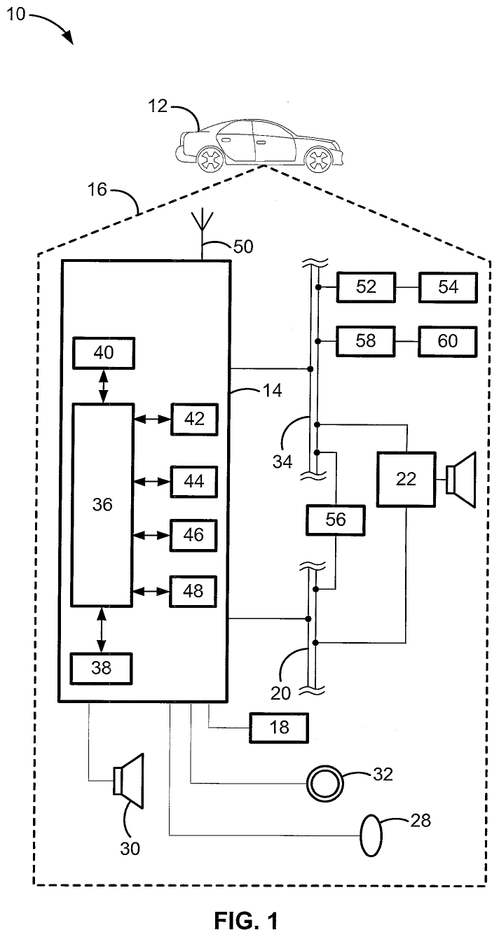

Referring now to the drawings, wherein like reference numbers refer to like features throughout the several views, there is shown in FIG. 1 a schematic illustration of a representative automobile, which is designated generally at 10 and portrayed herein for purposes of discussion as a four-door sedan-style passenger vehicle. Packaged within a vehicle body 12 of the automobile 10, e.g., distributed throughout the different vehicle compartments, is an onboard network of controllers, such as the assorted computing devices and electronic control units described below. The illustrated automobile 10—also referred to herein as “motor vehicle” or “vehicle” for brevity—is merely an exemplary application with which aspects and features of this disclosure may be practiced. In the same vein, implementation of the present concepts for the specific number and type of computing devices illustrated in FIG. 1 should also be appreciated as an exemplary application of the concepts and features disclosed herein. As such, it will be understood that aspects and features of this disclosure may be applied to any number and type and arrangement of networked controllers and devices, implemented by any logically relevant type of motor vehicle, and utilized for both automotive and non-automotive applications alike. Moreover, only select components of the vehicle 10 have been shown and will be described in additional detail herein. Nevertheless, the motor vehicles and network architectures discussed herein can include numerous additional and alternative features, and other suitable peripheral components, for example, for carrying out the various methods and functions of this disclosure. Lastly, the drawings presented herein are not necessarily to scale and are provided purely for instructional purposes. Thus, the specific and relative dimensions shown in the drawings are not to be construed as limiting.

The representative vehicle 10 of FIG. 1 is originally equipped with a vehicle telecommunication and information (colloquially referred to as “telematics”) unit 14 that communicates with a wireless communication system (e.g., cell towers, base stations and/or mobile switching centers (MSCs), etc.; not shown). Some of the other vehicle hardware 16 shown generally in FIG. 1 includes, as non-limiting examples, a display device 18, a microphone 28, a speaker 30, and input controls 32 (e.g., buttons, knobs, switches, keyboards, touchscreens, etc.). Generally, these hardware 16 components enable a user to communicate with the telematics unit 14 and other systems and system components within the vehicle 10. Microphone 28 provides a vehicle occupant with means to input verbal or other auditory commands, and can be equipped with an embedded voice processing unit utilizing human machine interface (HMI) technology. Conversely, speaker 30 provides audible output to a vehicle occupant and can be either a stand-alone speaker dedicated for use with the telematics unit 14 or can be part of a vehicle audio system 22. The audio system 22 is operatively connected to a network connection interface 34 and an audio bus 20 to receive analog information, rendering it as sound, via one or more speaker components.

Communicatively coupled to the telematics unit 14 is a network connection interface 34, suitable examples of which include twisted pair/fiber optic Ethernet switch, internal/external parallel/serial communication bus, a LAN, a controller area network (CAN), a media oriented system transfer (MOST), a local interconnection network (LIN), and the like. Other suitable communication interfaces may include those that conform with applicable ISO, SAE, and IEEE standards and specifications. The network connection interface 34 enables the vehicle hardware 16, including the telematics unit 14, to send and receive signals with each other and with various systems and subsystems both within the vehicle body 12 and external to the vehicle 10 to perform various vehicle functions, such as unlocking a vehicle door, positioning and orienting a vehicle seat, controlling engine throttle, engaging/disengaging the brake system, modifying a steering wheel angle and/or velocity, and the like. For instance, telematics unit 14 receives and/or transmits data to/from a brake system control module (BCM) 52, an engine control module (ECM) 54, an infotainment application module 56, sensor interface module(s) 58, and assorted other vehicle ECUs 60, such as a transmission control module (TCM), a climate control module (CCM), a powertrain control module (PCM), etc.

With continuing reference to FIG. 1, telematics unit 14 is an onboard computing device that provides a mixture of services, both individually and through communication with other networked devices. This telematics unit 14 is generally composed of one or more processors, which may be embodied as a discrete microprocessor, an application specific integrated circuit (ASIC), a central processing unit (CPU) 36, etc., operatively coupled to one or more electronic memory devices 38, each of which may take on the form of a CD-ROM, magnetic disk, integrated circuit (IC) device, semiconductor memory (e.g., various types of RAM or ROM), etc., and a real-time clock (RTC) 46. Communication capabilities with remote, off-board networked devices is provided via one or more or all of a cellular chipset/component 40, a wireless modem 42, a navigation and location chipset/component 44 (e.g., global positioning system (GPS)), a short-range wireless communication device 48 (e.g., a Bluetooth® unit), and/or a dual antenna 50. It should be understood that the telematics unit 14 may be implemented without one or more of the above listed components, or may include additional components and functionality as desired for a particular end use.

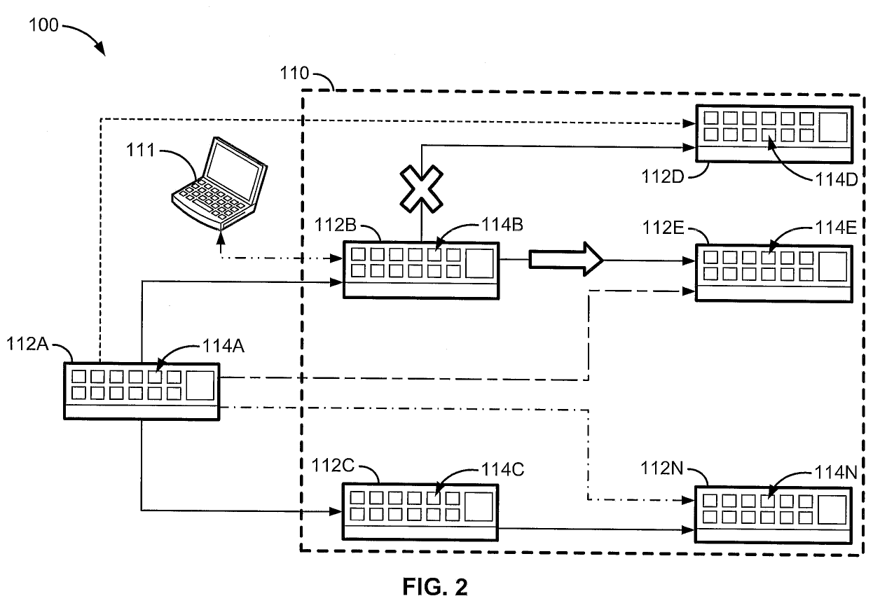

Turning next to FIG. 2, there is shown a representative in-vehicle Ethernet network 100 that is designed to support digital data communications with and between multiple electronic controllers and computing devices (collectively “controllers”) 112A, 112B, 112C, 112D, 112E . . . 112N of a motor vehicle 110. As indicated above, controllers 112A-112N may be in the nature of vehicle system modules and other onboard and remote electronic hardware components that are located throughout a vehicle 110 and receive inputs from one or more occupants, sensors, onboard or remote component, etc., and use these inputs to perform monitoring, control, diagnostics, reporting and/or other functions. Each of the controllers 112A-112N is shown communicatively connected to one another and to one or more remote devices by an embedded array of Ethernet switches 114A, 114B, 114C, 114D, 114E . . . 114N. While differing in appearance, it is envisioned that any of the features disclosed above with reference to the in-vehicle network architecture of FIG. 1 can be incorporated, singly or in any combination, into the networked architecture 100 of FIG. 2, and vice versa. By way of non-limiting example, the controllers 112A-112N of FIG. 2 may take on any of the corresponding in-vehicle device configurations described above with respect to FIG. 1, such as telematics unit 14, display device 18, audio system 22, BCM 52, ECM 54, infotainment application module 56, sensor interface module(s) 58, other vehicle ECUs 60, etc. In FIG. 2, the arrows interconnecting the various illustrated components are emblematic of electronic signals or other communication exchanges by which data and/or control commands are transmitted, wired or wirelessly, from one component to the other.

In the illustrated example of FIG. 2, the vehicle 110 is provided with intrusion protection, detection and remediation functionality as described below. During vehicle operation, the network 100 may be subject to different types of suspicious activities, including attempts to breach and manipulate the operation of one or more of the vehicle's controllers 112A-112N. This suspicious activity may come in various forms, such as, but not limited to, denial of service (DoS) attacks, phishing, spoofing, spamming, network overflows, and hijacking. A DoS attack is any type of intrusion where an attacker (hacker) attempts to prevent legitimate access to and use of a service from a network device or resource. A DoS attack may be typified by an attacker intentionally flooding a target controller with superfluous requests in order to overburden that controller and prevent legitimate requests from being received and fulfilled. A DoS intrusion generally causes degradation in controller performance and disruption in overall system functionality and operation. According to the illustrated example, a third-party (perpetrator) device 111 has invaded the network 100 and compromised the second controller 112B. Once hijacked, the third-party device 111 prevents the second controller 112B from sending legitimate network traffic to the fourth controller 112D (as indicated by the enlarged “X” superposed on the arrow connecting controllers 112B and 112D); this, in turn, disables the fourth controller 112D from performing one or more of its normal functions. Additionally, the third-party device 111 exploits the compromised controller 112B to inundate the fifth controller 112E with excessive demands, e.g., to authenticate requests that have invalid return addresses (as indicated by the enlarged arrow superposed on the arrow connecting controllers 112B and 112E). Both security-breaching intrusions cause a disruption of functionality in a networked controller and a compromise in the integrity of the network.

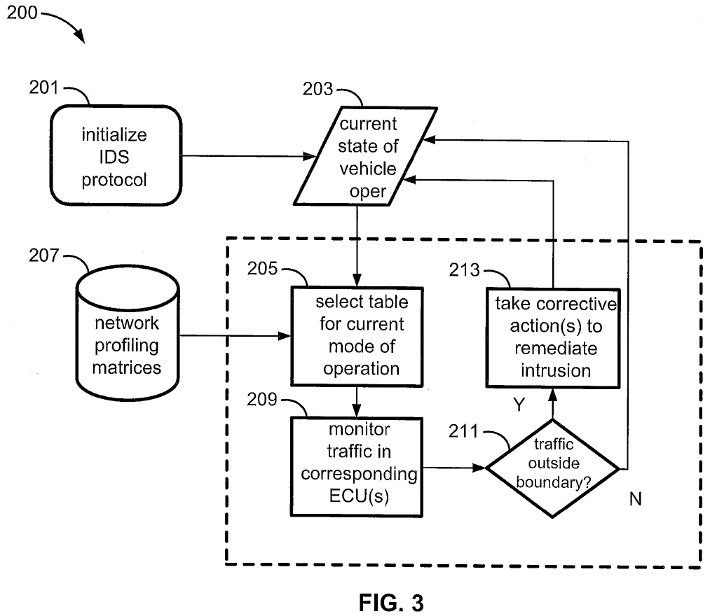

With reference now to the flowchart of FIG. 3, an improved method or control strategy for detecting an intrusion into an onboard network of electronic controllers, such as network 100 of FIG. 2, that is distributed throughout a motor vehicle, such as automobile 10 of FIG. 1, is generally described at 200 in accordance with aspects of the present disclosure. Some or all of the operations illustrated in FIG. 3 and described in further detail below may be representative of an algorithm that corresponds to processor-executable instructions that may be stored, for example, in main or auxiliary or remote memory, and executed, for example, by an on-board or remote ECU, central processing unit (CPU), vehicle control logic circuit, or other module or device, to perform any or all of the above and below described functions associated with the disclosed concepts. It should be recognized that the order of execution of the illustrated operation blocks may be changed, additional blocks may be added, and some of the blocks described may be modified, combined, or eliminated. Routines may be executed in real-time, continuously, systematically, sporadically and/or at regular intervals, for example, each 100 microseconds, 3.125, 6.25, 12.5, 25 and 100 milliseconds, etc., during ongoing vehicle use or operation. Alternatively, routines may be executed in response to occurrence of an event during operation of a vehicle.

Method 200 begins at terminal block 201 with processor-executable instructions for a programmable controller, such as a Central Control Module (CCM) or a General Electronic Module (GEM), to call up an initialization procedure for an intrusion detection system (IDS) protocol to identify and ameliorate an intrusion into one or more in-vehicle controllers. In at least some embodiments, network traffic across an embedded Ethernet switch for a designated controller is monitored in real time, a network traffic characteristic (e.g., frequency of messages for a traffic flow from a given node) is analyzed, and an anomaly is flagged if the analyzed characteristic is outside a vehicle-calibrated boundary (e.g., the frequency of messages exceeds a threshold value defined by off-line vehicle emulation and mapping). Utilization of the method 200 will help to identify various types of attacks, including the intentional transmission of misordered messages (irrespective of frequency), a traffic burst intentionally sized to exceed an Ethernet medium's bandwidth, a disruption of crucial communications, other DoS attacks and resultant systematic faults, etc. For at least some implementations, the method 200 detects an attack or systematic fault by leveraging knowledge of network traffic patterns. Using network traffic information as the primary (if not sole) metric to detect an intrusion provides for lower computational overhead when compared to other methods available for in-vehicle implementation. This also allows the IDS method 200 to be independent of automotive network domains and topology and, thus, may be scaled and adapted to different vehicle platforms. Disclosed methods may adapt network traffic pattern analysis to an individual driver based, for example, on the driver's driving behavior and consequent in-vehicle Ethernet traffic patterns.

Prior to, contemporaneous with, or after executing the operation or operations associated with terminal block 201, method 200 of FIG. 3 continues to input/output block 203 to receive, retrieve or otherwise determine a current state of operation of the motor vehicle. In an example, one of the networked controllers 112A-112N of FIG. 2 is embodied as an external object calculation module (EOCM) that is operable to execute a vehicle-assisted maneuver, e.g., for an autonomous vehicle operation, of vehicle 110. A primary EOCM may be programmed to selectively actuate a power steering motor, a motor-driven throttle valve, and/or hydraulic brake actuators to supplement one or more driver inputs, to counteract one or more driver inputs, and/or to assume driving control independent of driver input. A vehicle's current state of operation may be read from the EOCM in response to a prompt from the CCM or GCM. Operational states in autonomous driving scenarios may be in the form of electronic signals indicating an SAE Level 0-5 driving mode. SAE Level 0, for example, is generally typified as “unassisted” driving that allows for vehicle-generated warnings with momentary intervention, but otherwise relies solely on human control. By comparison, SAE Level 3 allows for unassisted, partially assisted, and fully assisted driving with sufficient vehicle automation for full vehicle control (steering, speed, acceleration/deceleration, etc.), while obliging driver intervention within a calibrated timeframe. At the upper end of the spectrum is Level 5 automation that altogether eliminates human intervention (e.g., no steering wheel, gas pedal, or shift knob). An autonomous activation interface, such as a center-stack HMI that communicates with the EOCM, may be programmed to activate or deactivate a level of autonomous-controlled driving based on a user-desired operational state input and surrounding environmental conditions. It is envisioned that vehicle state of operation may be ascertained using other means and inputs without departing from the intended scope of this disclosure. For instance, a vehicle ECU may be configured to receive a driver input in the form of an electronic signal, such as through physical operation by the driver of a steering wheel, an accelerator pedal, and/or a brake pedal, and to determine from that signal a corresponding operating state.

A current state of operation of a motor vehicle may include a static scenario, in which a single driving mode is calibrated to a specific type of vehicle, and a dynamic scenario, in which multiple driving modes are calibrated to a specific type of motor vehicle. By way of example, and not limitation, the network traffic pattern table corresponding to the single driving mode of the static scenario may consist of a single table that is stored by and extracted from a monitored vehicle controller. In effect, in a static scenario, the network patterns do not change from mode to mode (one “mode” of operation); as such, there is a single driving mode for a type of vehicle (e.g., autonomous driving SAE Level 2 urban or SAE Level 3 freeway). For static traffic flows, the IDS logic may identify the network patterns offline, and store the patterns in a suitable data structure in ECUs in the vehicle. At run-time for a static traffic flow, the IDS logic may check the stored data structures and compare them to real-time collected data. Contrastingly, for dynamic traffic flows, the network traffic pattern table corresponding to a dynamic driving mode may be selected from multiple tables, which are stored by and extracted from the monitored electronic controller or controllers of the motor vehicle. For dynamic traffic flows, network patterns may vary from “mode” to “mode” and at different operational states; as such, traffic flow may be said to depend on the modes of operation. Each monitoring ECU may store multiple tables with traffic patterns from offline testing, as described in further detail below. At run-time for a dynamic traffic flow, the IDS logic monitors traffic and calls up the appropriate table for the corresponding mode.

Process block 205 includes a resident or remote vehicle controller, such as resident controller 112B in collaboration with remote controller 112A of FIG. 2, executing a corresponding set of memory-stored instructions to determine, retrieve, or otherwise identify one or more network traffic pattern tables that correspond to the current state of operation of the vehicle. A network traffic pattern table, an example of which is provided below in Table 1, may be stored as resident data (e.g., maintained in non-volatile auxiliary memory of a monitoring ECU), stored locally (e.g., maintained in read-only memory (ROM) of a monitored vehicle ECU), and/or stored remotely (e.g., maintained by a backend server computer). In a non-limiting example, a monitoring ECU may store multiple traffic pattern tables for the assorted vehicle operating modes. Each network traffic pattern table may be built “offline,” e.g., using data collected from test bench Ethernet networks while exchanging data during emulated vehicle driving. Traffic flows are then mapped and profiled for each driving mode, with calibrated lower and/or upper thresholds established for select network flow characteristics. Offline testing may utilize vehicle emulation to account for different driving scenarios under different driving conditions, all the while collecting data to identify the normal operational limits of network traffic. Another viable option is to collect data during on-road vehicle testing and/or in real-time during end-user vehicle operation, and analyze the collected data to evaluate the regions of acceptant network patterns. Offline computed, mode-related network profiling matrices may be retrieved from a remote database server, as indicated by relational database 207 of FIG. 3.

TABLE 1

| Source | Destination | | | |
|---|---|---|---|---|
| Ethernet | Ethernet | | End-to-end Latency | |
| Switch | Switch | Frequency | (msec) | Number of Packets |
| A | D | Min <= freq1 <= Max | Min <= delay1 <= Max | Min <= packets_num1 <= Max |
| A | F | Min <= freq2 <= Max | Min <= delay2 <= Max | Min <= packets_num2 <= Max |

At process block 209, the method 200 monitors network traffic flow for one or more of the networked vehicle controllers as each monitored controller exchanges data over an Ethernet communication interface during operation of the motor vehicle in the current state of operation. Runtime traffic monitoring across an Ethernet medium may involve receiving one or more Ethernet frames from data packets crossing a designated port of an Ethernet communication interface, and identifying a specified field within the Ethernet frame(s) with data indicative of one or more desired network traffic characteristics. A data packet that is communicated across an Ethernet link is generally referred to as an “Ethernet frame,” which transports a data payload that is generally preceded by a preamble and start frame delimiter (SFD). In the Ethernet frames received in a particular port of a switch of a designated ECU, there are specific fields indicating a header, a timestamp, source and destination switch data, etc. By collecting and analyzing data in these frames, the monitoring ECU may compute the different characteristics associated with the received frames (e.g., frequency, latency, and number of frames received in a particular time window).

Method 200 then proceeds to decision block 211 to determine if any of the traffic characteristics of the monitored network traffic flow is outside a respective calibrated boundary, which is extracted from a corresponding one of the network traffic pattern tables. Put another way, the IDS logic checks the boundaries of the network traffic patterns to realize possible anomalies on the network traffic flows. These boundaries may be established by statistical analysis, with the introduction of an appropriate confidence level, or by machine-learning techniques that are performed, e.g., by a backend server after collecting data for different scenarios. Each boundary may incorporate “relaxed” lower and upper thresholds so as to avoid the possibility of false positives. Characteristics that define network traffic patterns are inclusive of, but not exclusive to, singly and in any combination:
Source-destination pairs for a traffic flow (IDS monitors frames at both source and destination ECUs as well as switches)
Frequency of messages for a traffic flow (IDS monitors the overall rate of message arrival at a designated destination)
Number of messages from a source Ethernet switch (IDS monitors at the source and destination)
Latency of messages for a traffic flow (IDS monitors transmission and processing delays at the destination, e.g., by comparing a timestamp on the frame versus a current clock time on the receiving ECU)

This list of characteristics can be extended to include other variables that are indicative of regular network traffic patterns. As some non-limiting examples, the list may include EtherTypes, VLAN tags associated with in-vehicle Ethernet networks, etc.

In response to any one of the traffic characteristics associated with the monitored network traffic flow falling outside of its respective calibrated boundary (Block 211=YES), the method 200 proceeds to process block 213 and executes one or more corrective actions to remediate the network intrusion event accompanying the anomaly in network traffic flow. If a characteristic that defines network traffic patterns is not within calibrated boundaries, the IDS logic may raise an alarm and concomitantly inform a governing system controller about a possible attack. This alarm may then be input to an intrusion prevention system (IPS) that is operable to decide what, if any, counteractive measures will be taken to stop and/or offset the attack (e.g., turn the system to a safe mode to investigate or limit the effect of the attack). The remedial action of process block 213 may take any many different forms, such as transmitting an audio and/or visual alert to the vehicle driver warning them of a potential attack and the possible loss of vehicle functionality; transmitting an electronic alert to a manufacturer's or service provider's remote server indicating the detection of an anomaly and potential attack; generating an interrupt signal to discontinue any further exchange of data by the compromised controller; and/or storing in a memory device a record of detected anomaly (e.g., date of intrusion, type of anomaly, ID of corrupted ECU, etc.). At this juncture, the method 200 of FIG. 3 may loop back to terminal block 201 or input/output block 203, or may terminate and reset. Likewise, if none of the traffic characteristics associated with the monitored network traffic flow falls outside of its respective calibrated boundary (Block 211=NO), the method 200 may responsively loop back to block 203.

Aspects of this disclosure may be implemented, in some embodiments, through a computer-executable program of instructions, such as program modules, generally referred to as software applications or application programs executed by an onboard vehicle computer. The software may include, in non-limiting examples, routines, programs, objects, components, and data structures that perform particular tasks or implement particular abstract data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, bubble memory, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by remote-processing devices that are linked through a communications network. In a distributed-computing environment, program modules may be located in both local and remote computer-storage media including memory storage devices. Aspects of the present disclosure may therefore, be implemented in connection with various hardware, software or a combination thereof, in a computer system or other processing system.

Any of the methods described herein may include machine readable instructions for execution by: (a) a processor, (b) a controller, and/or (c) any other suitable processing device. Any algorithm, software, or method disclosed herein may be embodied in software stored on a tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well-known manner (e.g., it may be implemented by an application specific integrated circuit (ASIC), a programmable logic device (PLD), a field programmable logic device (FPLD), discrete logic, etc.). Further, although specific algorithms are described with reference to flowcharts depicted herein, persons of ordinary skill in the art will readily appreciate that many other methods of implementing the example machine readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and obvious variations apparent from the foregoing descriptions are within the scope of the disclosure as defined by the appended claims. Moreover, the present concepts expressly include any and all combinations and subcombinations of the preceding elements and features.

What is claimed:

1. A method for detecting an intrusion into an onboard network of electronic controllers of a motor vehicle, the onboard network being wirelessly connected via an Ethernet communication interface to a distributed computing network, the method comprising:
determining, via a vehicle controller communicatively connected to the onboard network of electronic controllers, a current state of operation of the motor vehicle;
identifying, via the vehicle controller from a memory device, a network traffic pattern table corresponding to the current state of operation of the motor vehicle;
monitoring a network traffic flow for a corresponding one of the electronic controllers when exchanging data over the Ethernet communication interface while the motor vehicle is operating in the current state of operation;
determining if a traffic characteristic of the monitored network traffic flow is outside a calibrated boundary determined from the network traffic pattern table; and
executing, via the vehicle controller, a remedial action in response to the traffic characteristic of the monitored network traffic flow being outside the calibrated boundary.

2. The method of claim 1, wherein monitoring the network traffic flow of the corresponding one of the electronic controllers includes receiving one or more Ethernet frames from a designated port of the Ethernet communication interface.

3. The method of claim 2, wherein monitoring the network traffic flow of the corresponding one of the electronic controllers further includes identifying, within the one or more Ethernet frames, a specified field with data indicative of the traffic characteristic.

4. The method of claim 1, wherein the current state of operation of the motor vehicle includes a static scenario with a single driving mode calibrated to a type of the motor vehicle.

5. The method of claim 4, wherein the network traffic pattern table corresponding to the single driving mode of the static scenario is a single table stored by and extracted from the memory device of the monitored corresponding one of the electronic controllers.

6. The method of claim 1, wherein the current state of operation of the motor vehicle includes a dynamic scenario with multiple driving modes calibrated to a type of the motor vehicle.

7. The method of claim 6, wherein the network traffic pattern table corresponding to the dynamic driving mode is selected from multiple tables stored by and extracted from the memory device of the monitored corresponding one of the electronic controllers.

8. The method of claim 1, wherein the remedial action includes transmitting an audio and/or visual alert to a driver of the motor vehicle, transmitting an alert to a remote server indicating detection of an anomaly, generating an interrupt signal to discontinue exchanging of data by the corresponding one of the electronic controllers, modifying an automated driving maneuver of the motor vehicle, and/or storing in the memory device a record of detected anomaly.

9. The method of claim 1, wherein one of the electronic controllers is an external object calculation module (EOCM) operable to execute a vehicle-assisted maneuver, the current state of operation of the motor vehicle being received from the EOCM.

10. The method of claim 1, wherein identifying the network traffic pattern table includes: querying a remote database server as the memory device; and receiving the network traffic pattern table from the remote database server.

11. The method of claim 1, wherein the traffic characteristic includes a source-destination pair, a message frequency value, a message quantity value, and/or a traffic flow latency value.

12. The method of claim 1, wherein the Ethernet communication interface is embedded within the corresponding one of the electronic controllers.

13. The method of claim 1, wherein the network traffic flow for the corresponding one of the electronic controllers is monitored in real-time.

14. A motor vehicle comprising:
a vehicle body;
a network of electronic control units (ECU) attached to the vehicle body;
an Ethernet communication interface wirelessly connecting the network of ECUs to a distributed computing network; and
a vehicle controller communicatively connected to the network of ECUs and programmed to:
determine a current state of operation of the motor vehicle;
identify a network traffic pattern table corresponding to the current state of operation of the motor vehicle;
monitor a network traffic flow for a corresponding one of the ECUs when exchanging data over the Ethernet communication interface while the motor vehicle is operating in the current state of operation;
determine if a traffic characteristic associated with the monitored network traffic flow is outside a calibrated boundary determined from the network traffic pattern table; and
execute a remedial action in response to the traffic characteristic of the monitored network traffic flow being outside the calibrated boundary.

15. The motor vehicle of claim 14, wherein monitoring the network traffic flow of the electronic controller includes receiving one or more Ethernet frames from a designated port of the Ethernet communication interface.

16. The motor vehicle of claim 15, wherein monitoring the network traffic flow of the electronic controller further includes identifying, within the one or more Ethernet frames, a specified field with data indicative of the traffic characteristic.

17. The motor vehicle of claim 14, wherein the current state of operation of the motor vehicle includes a static scenario with a single driving mode calibrated to a type of the motor vehicle.

18. The motor vehicle of claim 17, wherein the network traffic pattern table corresponding to the single driving mode of the static scenario is a single table stored by and extracted from the monitored corresponding one of the electronic controllers.

19. The motor vehicle of claim 14, wherein the current state of operation of the motor vehicle includes a dynamic scenario with multiple driving modes calibrated to a type of the motor vehicle.

20. The motor vehicle of claim 19, wherein the network traffic pattern table corresponding to the dynamic driving mode is selected from multiple tables stored by and extracted from the monitored corresponding one of the electronic controllers of the motor vehicle.
